(19) United States
(12) Patent Application Publication
(10) Pub. No.: US 2009/0191407 A1
(43) Pub. Date: Jul. 30, 2009

(54) COATINGS PROVIDING LOW SURFACE EMISSIVITY

(76) Inventors: Ronald J. Lewarchik, Brighton, MI (US); Thomas D. Culp, La Crosse, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/356,805

(22) Filed: Jan. 21, 2009

Related U.S. Application Data
(60) Provisional application No. 61/022,095, filed on Jan. 18, 2008.
(60) Provisional application No. 61/059,308, filed on Jun. 6, 2008.

(51) Int. Cl. B32B 27/30; H01B 1/12; H01B 1/22; H01B 1/24; C08K 3/08

(52) U.S. Cl. 428/339; 252/500; 252/513; 252/514; 252/512; 252/511; 252/519.21; 524/439

(57) ABSTRACT

Coating compositions which reduce the surface emissivity of structural materials or maintain the surface emissivity of structural materials while protecting the structural materials from oxidation, weathering, and physical damage. The compositions comprise a polymerized organic monomer, an optional dispersible electrically conductive material, a catalyst, and a solvent.

### CROSS REFERENCE TO RELATED APPLICATIONS

This application claims the benefit of priority to U.S. Provisional Application No. 61/022,095, filed Jan. 18, 2008, and to U.S. Provisional Application No. 61/059,308, filed Jun. 6, 2008, both of which are incorporated herein by reference in their entirety.

### STATEMENT REGARDING FEDERALLY FUNDED RESEARCH

This invention was made with U.S. government support under DOE Contract # DE-FC26-05NT42321 awarded by the United States Department of Energy. The government has certain rights in the invention.

### FIELD OF THE INVENTION

The present invention relates to durable coatings that reflect electromagnetic radiation and may be used to increase the energy efficiency of climate-controlled spaces such as the interior of a building or vehicle.

### BACKGROUND

Rising energy costs and concerns over global warming have increased awareness of energy consumption. When consumers and businesses reduce their energy consumption, they save money and reduce the rate at which greenhouse gases are added to the atmosphere.

One of the best ways for consumers and businesses to save energy is to incorporate energy-efficient products into their homes or buildings. These products include fiberglass and cellulose insulation, as well as energy-efficient windows and doors. Energy-efficient windows and doors incorporate insulating materials as well as multiple panes of sealed glass to reduce conductive and convective heat loss/gain. Energy-efficient windows and doors also employ specialty coatings on the glass to increase the amount of radiant heat (e.g. infrared radiation) that they reflect. Such coatings reduce radiative heat transfer, which is particularly important for reducing heating costs in the winter as radiant interior heat loss is minimized.

The emissivity of a material (usually written ε) is the ratio of energy radiated by the surface of the material to energy radiated by a black body at the same temperature. It is a measure of a material's ability to absorb and radiate energy. A true black body would have an ε=1 while any real object would have ε<1. Emissivity is a numerical value and does not have units. In practice, low emissivity is related to high reflectance of radiation, and reduced radiative heat transfer to and from that material surface. For applications involving radiative heat transfer at relatively normal temperatures, such as in building applications, the primary wavelength range where it is most beneficial to have low emissivity is between 4 and 40 μm, which covers the blackbody infrared emission curve at 70° F. There are other applications where it can be beneficial to have low emissivity and high reflectivity in the near-infrared range (0.7 to 2.5 μm) to reflect the non-visible portion of sunlight away from the material. Where appropriate, building materials such as glazing in windows and doors are rated on an emissivity scale, and are advertised as “low-emissivity” or “low-e.”

The infrared emissivity of a surface can also be linked to the electrical conductivity of the material through the interaction of light and electrons at or near the material surface. A surface that has high electrical conductivity, such as most metals, will have a low emissivity (and a high reflectivity) of infrared light. However, because emissivity is a surface property, the important factor is the electrical conductivity at or near the surface where the light and the electrons interact, not the electrical conductivity in the bulk of the material. As a consequence, if the surface of the material differs than the bulk material, such as being covered with a coating with enough thickness that infrared light cannot penetrate to the bulk material, the emissivity will be determined by the surface or coating properties, not the bulk material.

While energy efficiency is a desired characteristic for building materials, it is typically only one of the factors considered in choosing a structural material. In general, desirable building products should also be strong, inexpensive, durable, and easy to work with.

Aluminum has many of the characteristics desired in building materials. It is fairly inexpensive, strong, and easy to work with. Consequently modern buildings employ a great deal of aluminum, especially for door and window frames. Freshly-milled aluminum also has the desired characteristic of low emissivity due to the reflectivity and high electrical conductivity of the clean aluminum surface. Unfortunately, over time aluminum loses its inherent reflectivity as the surface grows an oxidation layer, which is not electrically conductive and has a high infrared emissivity. As the oxidation layer grows in thickness, the electrically conductive aluminum surface is covered, and the resulting nonconductive surface with higher emissivity becomes steadily less reflective. Over time, the oxidation layer can also disrupt the structural integrity of the material. Furthermore, the oxidation layer is considered unattractive. Oxidation and weathering issues are not limited to aluminum, however, as many other common building materials, e.g. steel, also grow disruptive oxide layers.

In order to combat oxidation, structural materials are often coated, with paint for example, to stop the oxidation. Coating the materials also increases decorative options, as different coating may have different colors and sheens. For exterior applications, there are a variety of specifications for coatings on aluminum, such as from the American Architectural Manufacturing Association (AAMA), depending on the desired performance. Unfortunately, in most cases, the coating has high surface emissivity, typically around 0.9, which negates the inherent low emissivity of the underlying structural material. Thus, manufacturers must trade durability and aesthetics against energy efficiency.

Polyvinylidene fluoride (PVDF) coatings are among the most durable coatings available for structural materials. Compared to conventional paint, PVDF provides exceptional weathering characteristics and resistance to wear and damage. PVDF coatings can be comprised of multiple binder ratios of PVDF homo-polymer and acrylic or methacrylic homo-polymer or copolymers. However, PVDF-based coatings present multiple unique challenges, such as proper flow, storage stability, and manufacturing difficulties. Additionally, unless the composition is properly balanced with the correct choice of acrylic resin and solvent, mud cracking can occur, especially when the product is exposed to ovens without proper staging. Finally, standard PVDF coatings have a high surface emissivity, typically around 0.9, which is not desirable in applications where radiative heat transfer needs to be reduced, such as building components. Architectural PVDF coatings are available from a variety of manufacturers including Solvay Solexis (Bollate, Italy) and Arkema, Inc. (Philadelphia, Pa.).

### SUMMARY OF THE INVENTION

In one embodiment, the invention provides a composition for coating materials, comprising a resin comprising polymerized organic monomers, a dispersible electrically conductive material, a cross-linking catalyst, and a solvent. The organic monomers have at least one organic functional group, and the resin, dispersible electrically conductive material, catalyst, and solvent are mixed together to form a homogenous composition.

In another embodiment, the invention provides a method for producing coated articles with low surface emissivity. The method comprises coating an article with a composition comprising a resin comprising polymerized organic monomers, a dispersible electrically conductive material, a catalyst, and a solvent. The resin, dispersible electrically conductive material, catalyst, and solvent are mixed together to form a homogenous composition. After application and finishing, the coating typically has a thickness of less than 100 microns.

In another embodiment, the invention provides an alternative method for producing coated articles with low surface emissivity. The method comprises coating an article with a composition comprising a resin comprising polymerized organic monomers, a cross-linking catalyst, and a solvent. The resin, catalyst, and solvent are mixed together, with no dispersible electrically conductive material to form a homogenous composition. After application and finishing, the coating typically has a thickness of less than 10 microns.

In another embodiment, the invention provides articles with low surface emissivity, comprising an article coated with a composition consisting essentially of about 25-50% (w/w) resin comprising polymerized organic monomers, about 25-50% (w/w) dispersible electrically conductive material, about 25-50% (w/w) solvent, and about 0.001-0.01% (w/w) cross-linking catalyst. The resin, dispersible electrically conductive material, solvent, and cross-linking catalyst are mixed together to form a homogenous composition. After application and finishing, the coating has a thickness of less than 100 microns.

In another embodiment, the invention provides articles with low surface emissivity, comprising an article coated with a composition consisting essentially of about 30-60% (w/w) resin comprising polymerized organic monomers, about 40-70% (w/w) solvent, and about 0.01-1% (w/w) cross-linking catalyst. The resin, dispersible electrically conductive material, solvent, and cross-linking catalyst are mixed together to form a homogenous composition. The coating as a thickness of less than 10 microns.

Other aspects of the invention will become apparent by consideration of the detailed description and accompanying drawings.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

As used herein, “leafing” refers to metal flake pigments wherein the metal flakes are chosen or treated such that the resultant coatings have the flakes oriented at or near the surface with the application of the coating. In contrast, “non-leafing” metal flake pigments result in a coating with a lower level metal flake oriented at the surface. The methods for creating leafing or non-leafing metal flake pigments are known to those of skill in the art. “Flash-off” refers to blowing on and or heating a material that was recently coated in order to remove solvents.

The invention provides compositions for coating structural materials to provide a low infrared surface emissivity. The compositions comprise a resin, typically made of organic monomer units, a dispersible electrically conductive material, such as metal flakes or metal-coated fibers or beads, a cross-linking catalyst, and a solvent. When the coating is applied to structural materials, such as aluminum window frames, the coating provides a low emissivity surface, improves the look of the material, and protects the material from physical damage from exposure to the elements and/or mechanical abrasion. This coating may also contain pigments or adhesive agents, as desired, to change the color or adhesion properties.

The invention additionally provides alternative compositions for coating structural materials to maintain low infrared surface emissivity. Unlike the other compositions of the invention, this alternate composition does not contain dispersible electrically conductive material. This alternate coating typically comprises a resin, a cross-linking catalyst, and a solvent. This coating is used to protect and improve the look of low-emissivity materials, with little change in emissivity.

The invention additionally provides combinations of low-emissivity coatings, e.g., a low-emissivity primer and a low-emissivity top coat. In some applications, it may be desirable to use a combination of a primer and a top coat to improve the adhesion of the coating to the material, or to increase the durability of the coating.

The invention relates to coatings that may be used to provide a low emissivity surface to a substrate coated therewith. In general the coatings are a composition of organic resins (such as PVDF, acrylic, alkyds, polyesters, polyethers, polyureas, polyurethanes, polyketones, fluoropolymers, or epoxies), a dispersible conductive material (such as metal flakes or metal-coated glass fibers), a cross-linker, a catalyst, and a solvent. The resulting coatings are highly reflective of electromagnetic radiation and protect the underlying substrate from weathering and mechanical damage. Dyes or pigments may be added to these coatings, in accordance with this invention, to change the resulting color of the coated substrate. Suitable pigments may include titanium dioxide, zinc oxide, carbon black or mixed metal oxide pigments. Suitable dyes for example may be chosen from the family of savinyl dyes, including red, yellow, blue, etc.

The weight-percent composition of the low-emissivity coating may vary depending upon the weight of the polymers and the dispersible electrically conductive materials. In some embodiments, the low emissivity coatings may comprise 25-50% (w/w) resin comprising polymerized organic monomers, about 25-50% (w/w) dispersible electrically conductive material, about 25-50% (w/w) solvent, and about 0.001-0.01% (w/w) cross-linking catalyst. Additional pigments or dyes may be added to these coatings as needed in order to achieve the desired color or hue.

The compositions and methods described in the invention are useful for producing coated articles that have low infrared surface emissivities. In some embodiments, the articles are produced from metal, especially aluminum, however, the articles need not be limited to metal. For example, articles may be produced from wood, plastic, glass, stone, brick, etc. Coated articles with low surface emissivity according to the invention may be incorporated into many different products. In some embodiments, the coated articles with low surface emissivity may be building materials, including, but not limited to window frames, doors, roof coverings, and exterior wall coverings.

While the compositions disclosed herein are primarily coatings in which the dispersible conductive material is aluminum flake or silver-coated fibers, a wide range of dispersible conductive material may be substituted as appropriate. For example, one skilled in the art could substitute gold, silver, copper, or nickel flakes for the dispersible conductive material. One skilled in the art could also substitute a wide variety of substrates coated with the above metals, such as gold-coated glass fibers, silver-coated glass beads, silver-coated ceramic beads, etc. One skilled in the art could also substitute materials using other electrically conductive or semiconductive materials such as conductive oxides or nitrides.

In most cases, it is beneficial to add a cross-linker and a catalyst to the composition to stimulate cross linking of appropriate reactants with a composition comprised of a functional polyacrylic resin and PVDF. Upon curing, the resulting cross-linked coatings are harder and more durable than coatings of the same monomers without cross-linking. In particular, amine salts of organic sulfonic acids are effective cross-linking catalysts for PVDF and acrylic monomers. For example, diisopropanolamine salts of para-toluene sulfonic acid. For additional strength and durability, it may be desirable to add crosslinkers, such as, but not limited to, aminoplasts, oxiranes, aziridines, and isocyanates. Where greater adhesion to the substrate is desired, it is also possible to add adhesive agents that bond tightly to the substrate and provide a structure that is amenable to linking to the organic monomers. Additionally, the substrate may be coated with a low-emissivity primer that has greater adhesion properties prior to coating with a composition disclosed herein.

In another embodiment, the coatings providing low emissivity surfaces may comprise compositions, with no dispersible conductive material, which can be applied in a very thin coat (e.g. 5 μm), yet still maintain superior hardness and durability. Such a coating may further comprise pigments to produce a desired final color in the coated product (e.g. white or beige).

The weight-percent composition of the low-emissivity coating with no dispersible conductive material may vary depending upon the weight of the polymers. In some embodiments, the low emissivity coatings, with no dispersible conductive material may comprise 30-60% (w/w) resin comprising polymerized organic monomers, about 40-70% (w/w) solvent, and about 0.01-1% (w/w) cross-linking catalyst. Additional pigments or dyes may be added to these coatings as needed in order to achieve the desired color or hue.

Prior to coating an article it may be desirable to treat the article to reduce the article's inherent emissivity or to make the coating bind more tightly to the article. Mechanical treatments may include grinding or polishing the substrate, while chemical treatments may include cleaning the substrate with a degreaser to remove drawing compounds and mill oils on the surface. The article may, alternatively or additionally, be dipped in an acid to remove an oxidation layer. Additional cleaning and pre-treating steps may include washing the article with a detergent or an organic solvent as well as depositing a thin chemical pre-treatment to provide an improved surface prior to the application of an organic coating.

It may also be desirable to coat the article with a primer to help the coating bind to the article, or to provide enhanced durability to the article. In some embodiments, a low emissivity primer may be used to decrease the total emissivity of the article to be coated. Such low emissivity primers may have formulations similar to the low emissivity coatings in that they comprise a resin, a dispersible electrically conductive material, a solvent and optionally a cross-linking catalyst. Low emissivity primers may additionally comprise adhesion agents, detergents, surfactants, and antifungal agents to achieve the desired primer properties.

In some instances, it may be desirable to coat a substrate having a low inherent emissivity purely to reduce the formation of oxides upon the substrate. For example polished aluminum has a low emissivity surface, but rapidly forms an oxide layer which increases the emissivity. A thin coating of clear resin will prevent an oxide layer from forming while still allowing infrared light to penetrate and interact with the underlying low emissivity material.

For all of the compositions described herein, it may be desirable to apply a coating of the composition that is less than 100 microns thick. Coating thickness is typically measured as a tangent, or perpendicular to, a surface. The thickness of a coating may be measured with an elcometer, for example, however many other techniques such as x-ray spectrometry, beta backscatter, and magnetic induction may be used where appropriate. Coatings less than 100 microns thick, in some cases, result in a coated material that has a lower emissivity than materials coated with a thicker coating of the same composition. In some cases, it is more desirable to have a coating that is less than or equal to 10 microns thick. A coating less than or equal to 10 microns may, in some cases, protect the underlying material from oxidation or other degradation yet maintain the inherent emissivity of the coated material. In some cases, it is desirable that the coating is greater than 1 micron thick, as a coating less than 1 micron thick may not adequately protect the underlying material from oxidation, weathering, or physical damage.

Depending upon the composition of the coating used, a low emissivity coating may have a range of hardness. Using a pencil hardness tester, low emissivity coatings of the invention may have a hardness measured as harder than or equal to B, typically harder than or equal to H, more typically harder than or equal to 2H.

The following examples serve to illustrate the principles of the invention, however the following examples are not intended to serve as a limitation on the principles of the invention. In most cases, the trade names are for illustrative purposes, as one skilled in the art could replace the trade-named ingredients with competing products with similar compositions. The proportions of the ingredients in the compositions should be interpreted as ranges rather than absolute numbers. One skilled in the art would be able to make acceptable compositions of the below coatings with some variation from the disclosed quantities. Furthermore, it is specifically understood that any numerical value recited herein includes all values from the lower value to the upper value, i.e., all possible combinations of numerical values between the lowest value and the highest value enumerated are to be considered to be expressly stated in this application. For example, if a concentration range or a beneficial effect range is stated as 1% to 50%, it is intended that values such as 2% to 40%, 10% to 30%, or 1% to 3%, etc., are expressly enumerated in this specification. These are only examples of what is specifically intended.

Quoted emissivity values for the below compositions may vary in actual use of the below compositions. In particular, the emissivity of test materials coated with Acrylic Clear formulations (below) will vary with the thickness of the final coating. Thicknesses are reported in microns unless otherwise stated.

### EXAMPLES

Test conditions—Aluminum test panels, such as those sold by Q-Lab (Cleveland, Ohio) under the trade name Q-PANEL, were cleaned with acetone and dried prior to being coated with the composition. Thickness, when stated, was measured with an Elcometer, using the procedures recommended by the manufacturer. Infrared emissivity, when stated, was measured with an emissometer, using the procedures recommended by the manufacturer.

### Example 1

### Compositions Comprising Non-Leafing Aluminum Flake Pigment

Xylene is slowly added with stirring to 93.8 grams of DURANAR brand Polyvinylidene Fluoride containing composition (PPG Industries, Springsdale, Pa.) until the resulting mixture has acceptable flow (as measured with a Daniel Flow gauge). 23.4 grams of SPARKLE SILVER non-leaf aluminum flake pigment (Silberline Manufacturing, Tamaqua, Pa.) is then added with continued stirring. Xylene is then added to the resulting mixture until the desired viscosity is achieved. A desired viscosity is typically 25-30 sec. flow time from a Ford # 4 viscosity cup (ASTM D1200). After the desired viscosity is achieved, 0.4 grams of cross-linking catalyst, such as CYCAT 4045 (diisopropanolamine salt of para-toluene sulfonic acid, Cytec Industries, West Patterson, N.J.), is added with vigorous stirring. The resulting mixture is filtered into a can with a size medium filter, and the mixture is then applied to the test material by spray. After 15 minutes of flash-off, the panels are cured in a 450° F. oven for 20 minutes. The coated material is then tested for thickness of coating and total emissivity.

Example 1 is exemplary of a composition comprising non-leafing aluminum flake pigment. One skilled in the art could calculate the appropriate weights of resin and non-leafing aluminum flake to produce acceptable compositions based upon Table 1 below.

TABLE 1
PVDF compositions comprising non-leafing aluminum flake pigment,
catalyst, and xylene. Test material = aluminum panel.

| | | Conductive | Conductive Material | Thickness | |
|---|---|---|---|---|---|
| Formulation | Polymer | Material | per weight formulation | (microns) | Emissivity |
| 1-A | PVDF | aluminum flake | 25% | 28 | 0.49 |
| 1-B | PVDF | aluminum flake | 30% | 28 | 0.45 |
| 1-C | PVDF | aluminum flake | 50% | 28 | 0.40 |
| 1-D | PVDF | aluminum flake | 70% | 28 | 0.34 |

### Example 2

### Compositions Comprising Leafing Aluminum Flake Pigment

Xylene is slowly added with stirring to 80.4 grams of DURANAR brand Polyvinylidene Fluoride containing composition (PPG Industries, Springsdale, Pa.) until the resulting mixture has acceptable flow (as measured with a Daniel Flow gauge). 87.5 grams of ETERNABRITE leafing aluminum flake pigment (Silberline Manufacturing, Tamaqua, Pa.) is then added with continued stirring. Xylene is then added to the resulting mixture until the desired viscosity is achieved. A desired viscosity is typically 25-30 sec. flow time from a Ford # 4 viscosity cup (ASTM D1200). After the desired viscosity is achieved, 0.4 grams of cross-linking catalyst, such as CYCAT 4045 (diisopropanolamine salt of para-toluene sulfonic acid, Cytec Industries, West Patterson, N.J.), is added with vigorous stirring. The resulting mixture is filtered into a can with a size medium filter, and the mixture is then applied to the test material by spray. After 30 minutes of flash-off at 120° F., the panels are cured in a 450° F. oven for 20 minutes. The coated material is then tested for thickness of coating and total emissivity.

Example 2 is exemplary of a composition comprising leafing aluminum flake pigment. One skilled in the art could calculate the appropriate weights of resin and leafing aluminum flake to produce acceptable compositions based upon Table 2 below.

TABLE 2
PVDF compositions comprising leafing aluminum flake pigment,
catalyst, and xylene. Test material = aluminum panel.

| | | Conductive | Conductive Material | Thickness | |
|---|---|---|---|---|---|
| Formulation | Polymer | Material | per weight formulation | (microns) | Emissivity |
| 2-A | PVDF | aluminum flake | 25% | 30 | 0.20 |
| 2-B | PVDF | aluminum flake | 70% | 30 | 0.19 |

### Example 3

### Compositions Comprising Silver Coated Fibers

Xylene is slowly added with stirring to 241.3 grams of DURANAR brand Polyvinylidene Fluoride containing composition (PPG Industries, Springsdale, Pa.) until the resulting mixture has acceptable flow (as measured with a Daniel Flow gauge). 210 grams of AGCLAD-12 silver-coated glass fiber (Potters Industries, Malvern, Pa.) is then added with continued stirring. Xylene is then added to the resulting mixture until the desired viscosity is achieved. A desired viscosity is typically 25-30 sec. flow time from a Ford # 4 viscosity cup (ASTM D1200). After the desired viscosity is achieved, 3.52 grams of cross-linking catalyst, such as CYCAT 4045 (diisopropanolamine salt of para-toluene sulfonic acid, Cytec Industries, West Patterson, N.J.), is added with vigorous stirring. The resulting mixture is filtered into a can with a size medium filter, and the mixture is then applied to the test material by spray. After 10 minutes of flash-off, the panels are cured in a 450° F. oven for 20 minutes. The coated material is then tested for thickness of coating and total emissivity.

Example 3 is exemplary of a composition comprising silver coated fibers. One skilled in the art could calculate the appropriate weights of resin and silver coated fibers to produce acceptable compositions based upon Table 3 below.

TABLE 3
PVDF compositions comprising silver-coated glass fibers, catalyst,
and xylene. Test material = aluminum panel.

| | | Conductive | Conductive Material | Thickness | |
|---|---|---|---|---|---|
| Formulation | Polymer | Material | per weight formulation | (microns) | Emissivity |
| 3-A | PVDF | silver-coated fiber | 30% | 40 | 0.45 |
| 3-B | PVDF | silver-coated fiber | 70% | 40 | 0.48 |

Silver-coated fiber/TiO₂ formulation: A small amount of titanium dioxide (TiO₂) can be added to the above compositions with little or no change in emissivity. First a TiO₂ dispersion is formulated by adding 330 grams of TiO₂ to a mixture of 80 grams of AT-400 acrylic resin (Rohm & Haas, Philadelphia, Pa.) and 170 grams of xylene while stirring in a high-speed disperser with a Cowles blade. Seventy-five grams of zirconia-silica beads are then added to the mixture, and the disperser allowed to run for 4 hours. The resulting dispersion is added to the compositions of Example 3 as described below.

Xylene is slowly added with stirring to 241.3 grams of DURANAR brand Polyvinylidene Fluoride containing composition (PPG Industries, Springsdale, Pa.) until the resulting mixture has acceptable flow (as measured with a Daniel Flow gauge). 210 grams of AGCLAD-12 silver-coated glass fiber (Potters Industries, Malvern, Pa.) is then added with continued stirring. Xylene is then added to the resulting mixture until the desired viscosity is achieved. A desired viscosity is typically 25-30 sec. flow time from a Ford # 4 viscosity cup (ASTM D1200). After the desired viscosity is achieved, 3.52 grams of cross-linking catalyst, such as CYCAT 4045 (diisopropanolamine salt of para-toluene sulfonic acid, Cytec Industries, West Patterson, N.J.), is added with vigorous stirring. After adding the catalyst, 16 grams of the above TiO₂ acrylic dispersion is stirred into the mixture. The resulting mixture is filtered into a can with a size medium filter, and the mixture is then applied to the test material by spray. After 10 minutes of flash-off, the panels are cured in a 450° F. oven for 20 minutes. The coated material is then tested for thickness of coating and total emissivity. The resultant silver-coated fiber/TiO₂ coating had an emissivity of 0.52 for a coating 43 microns thick.

### Example 4

### Acrylic Compositions Comprising Dyes Providing a Low Emissivity Coated Surface

Acrylic Clear Polymer suspension: A mixture of 100 grams of AT-400 acrylic resin (Rohm & Haas, Philadelphia, Pa.) and 30 grams of CYMEL-303 melamine resin (Cytec Industries, West Patterson, N.J.) is slowly added to a solution of 132 grams of methyl n-amyl ketone and 20 grams of isobutanol. Two grams of cross-linking catalyst, such as CYCAT 4045 (diisopropanolamine salt of para-toluene sulfonic acid, Cytec Industries, West Patterson, N.J.), are added with vigorous stirring. The resulting mixture is referred to hereafter as Acrylic Clear.

Acrylic Red formulation—One gram of savinyl red dye (Sandoz Inc., Mississauga, Ontario, Canada) is added to 100 grams of Acrylic Clear (formulation above) with stirring. The mixture is then reduced with xylene until a viscosity of 15-20 sec. flow time from a Ford #4 cup is achieved. Once the desired viscosity is achieved, 0.2 grams DC-57 wetting agent (Dow Corning, Midland, Mich.) is added to improve the wettability of the coating. The resulting mixture is filtered into a can with a size medium filter, and the mixture is then applied to the test material by spray. After 10 minutes of flash-off, the panels are cured in a 300° F. oven for 20 minutes. The coated material is then tested for thickness of coating and total emissivity.

Example 4 is exemplary of an acrylic composition comprising dyes providing a low emissivity coated surface. One skilled in the art could calculate the appropriate weights of acrylic and dye to produce acceptable compositions based upon Table 4 below.

TABLE 4
Acrylic compositions comprising low emissivity dyes, CYMEL 303,
catalyst, and xylene. Test material = aluminum panel.

| | | | Dye per weight | Thickness | |
|---|---|---|---|---|---|
| Formulation | Polymer | Dye | formulation | (microns) | Emissivity |
| 4-A | Acrylic Clear | savinyl orange | 2% | 6 | 0.43 |
| 4-B | Acrylic Clear | savinyl red | 2% | 6 | 0.41 |
| 4-C | Acrylic Clear | savinyl yellow | 2% | 6 | 0.55 |

### Example 5

### Low Emissivity Primers

Xylene is slowly added with stirring to 87.1 grams of DURANAR brand Polyvinylidene Fluoride containing composition (PPG Industries, Springsdale, Pa.) until the resulting mixture has acceptable flow (as measured with a Daniel Flow gauge). 27.3 grams of SPARKLE SILVER non-leaf aluminum flake pigment (Silberline Manufacturing, Tamaqua, Pa.) is then added with continued stirring. Xylene is then added to the resulting mixture until the desired viscosity is achieved. A desired viscosity is typically 25-30 sec. flow time from a Ford # 4 viscosity cup (ASTM D1200). After the desired viscosity is achieved, 0.4 grams of cross-linking catalyst, such as CYCAT 4045 (diisopropanolamine salt of para-toluene sulfonic acid, Cytec Industries, West Patterson, N.J.), is added with vigorous stirring. Next, 1.6 grams of EPON™-828 epoxy resin (Hexion Specialty Chemicals, Columbus, Ohio) is added to improve primer adhesion. The resulting primer mixture is filtered into a can with a size medium filter, and the mixture is then applied to the test material by spray. After 15 minutes of flash-off, the panels are cured in a 450° F. oven for 20 minutes. The coated material is then tested for thickness of coating and total emissivity. The resultant primer had an emissivity of 0.43 for a coating 25 microns thick.

### Example 6

### Low Emissivity White Top Coat

A titanium dioxide (TiO₂) dispersion is formulated by adding 17.6 grams of TiO₂ to a mixture of 60 grams of AT-400 acrylic resin (Rohm & Haas, Philadelphia, Pa.) and 50 grams of xylene while stirring in a high-speed disperser with a Cowles blade. Seventy-five grams of zirconia-silica beads are then added to the mixture, and the disperser allowed to run for 4 hours. At this point, the Hegman gauge particle size for the TiO₂ dispersion should be greater than 7.0. The dispersion is set aside until needed in the below mixture.

Xylene is slowly added with stirring to 80.4 grams of DURANAR brand Polyvinylidene Fluoride containing composition (PPG Industries, Springsdale, Pa.) until the resulting mixture has acceptable flow (as measured with a Daniel Flow gauge). 70.0 grams of AGCLAD-12 silver-coated glass fiber (Potters Industries, Malvern, Pa.) is then added with continued stirring. Methyl n-amyl ketone is then added to the resulting mixture until the desired viscosity is achieved. A desired viscosity is typically 25-30 sec. flow time from a Ford # 4 viscosity cup (ASTM D1200). After the desired viscosity is achieved, 0.4 grams of cross-linking catalyst, such as CYCAT 4045 (diisopropanolamine salt of para-toluene sulfonic acid, Cytec Industries, West Patterson, N.J.), is added with vigorous stirring. Next, 17.5 grams of the TiO₂ dispersion (above) is added with continued stirring. The resulting top coat mixture is filtered into a can with a size medium filter, and the mixture is then applied to the test material, previously coated with the low emissivity primer, by spray. After 15 minutes of flash-off, the panels are cured in a 450° F. oven for 20 minutes. The coated material is then tested for thickness of coating and total emissivity. The resultant low emissivity white top coat had an emissivity of 0.67 for a coating 5 microns thick.

### Example 7

### Low Emissivity Gray

Xylene is added to 76 grams of Acrylic Clear (Example 4) until the resulting mixture has acceptable flow (as measured with a Daniel Flow gauge). 23.4 grams of SPARKLE SILVER non-leafing aluminum flake pigment (Silberline Manufacturing, Tamaqua, Pa.) is then added with continued stirring. 79 grams of TiO₂ dispersion (Example 6) are then added with continued stirring. Xylene is then added to the resulting mixture until the desired viscosity is achieved. A desired viscosity is typically 25-30 sec. flow time from a Ford # 4 viscosity cup (ASTM D1200). After the desired viscosity is achieved, 0.8 grams of cross-linking catalyst, such as CYCAT 4045 (diisopropanolamine salt of para-toluene sulfonic acid, Cytec Industries, West Patterson, N.J.), is added with vigorous stirring. The resulting mixture is filtered into a can with a size fine filter, and the mixture is then applied to the test material by spray. After 10 minutes of flash-off, the panels are cured in a 300° F. oven for 20 minutes. The coated material is then tested for thickness of coating and total emissivity. The resultant low emissivity gray coating had an emissivity of 0.58 for a coating 11 microns thick.

### Example 8

### White Acrylic-Polyurethane Coating Providing a Low Emissivity Coated Surface

A white acrylic-polyurethane coating which provides a low emissivity coated surface was formed by making a 100:4:108 mixture of parts A, B, and C, described below:

PART A—9.5 grams of acrylic polyol (PARALOID AT-400, Rohm & Haas, Philadelphia, Pa.), 10.4 grams of dispersing agent (SOLSPERSE 36000, Lubrizol, Wickliffe, Ohio), and 35.6 g of methyl amyl ketone (MAK) (EMCO Chemicals, North Chicago, Ill.) was added to a kettle and stirred thoroughly. Forty grams of TiO₂ pigment (TI-PURE R-960, E.I. du Pont de Nemours and Co., Edge Moor, Del.) was then added to the kettle along with about 200 grams of 1.8 mm zirconium beads (Quackenbush, Crystal Lake, Ill.). The resulting mixture was then dispersed with a high-speed Cowles blade until the mixture achieved a fineness rating of 8 or greater on a Hegman gauge. The mixture was then filtered to remove any clumps. Next, 2.5 grams of epoxy resin (EPON 828, Miller Stephenson, Morton Grove, Ill.) was added to the mixture under constant agitation. Finally, 2 grams of dibutyl tin dilaurate catalyst (Sigma-Aldrich, St. Louis, Mo.) was added with stirring.

PART B—Aliphatic polyisocyanate resin to promote cross-linking (DESMODUR N 75 BA, Bayer Material Science, Pittsburgh, Pa.).

PART C—Twenty-one grams of Xylene (EMCO Chemicals, North Chicago, Ill.) was mixed with 86.4 grams of methyl ethyl ketone (EMCO Chemicals, North Chicago, Ill.) to create a solvent for the dispersion.

One hundred grams of PART A were mixed with 4 grams of PART B, resulting in an isocyanate index of approximately 1.2. The mixture of PARTS A and B was then thinned down with 108 grams of PART C to produce a low-emissivity white acrylic-polyurethane coating. The final coating had a viscosity of about 20 seconds by Ford # B4 viscosity cup (ASTM D1200).

The white acrylic-polyurethane coating was applied in a very thin coat (about 5 μm) to aluminum test panels using a conventional gravity feed spray gun with about 30 p.s.i. pressure at a distance of about 1 ft. The panels were subjected to 10-15 minutes of flash-off, and were then cured at 350° F. for 20 minutes. After being removed from the oven, the panels were allowed to cool for 20 minutes and then tested (see Table 5).

TABLE 5
Low-e white acrylic-polyurethane coating; test material = aluminum panel.

| | | | Pigment weight | Thickness | | |
|---|---|---|---|---|---|---|
| Formulation | Polymer | Pigment | of formulation | (microns) | Emissivity | L value |
| 8-A | Acrylic- | TiO₂ | 19% | 5 | 0.6 | 0.61 |
| | PU | | | | | |

The low-e white acrylic-polyurethane coating was also evaluated for adhesion and hardness. The low-e white acrylic-polyurethane coating passed the ASTM D 3359 initial adhesion test, and showed no signs of defects after 500 hours at 100° C. in a QCT (humidity) chamber. The low-e white acrylic-polyurethane coating had a pencil hardness of 2H, a mineral spirit solvent double rub score of greater than 50, and showed no sign of defects after being subjected to the WINDEX chemical resistance test for 24 hours. The low-e white acrylic-polyurethane coating also showed no blistering, fading, or discoloration after 500 hours in a QUV (ultraviolet light) chamber.

### Example 9

### Beige Acrylic-Polyurethane Coating Providing a Low Emissivity Coated Surface

A beige acrylic-polyurethane coating which provides a low emissivity coated surface was formed by making a 100:5:110 mixture of parts A, B, and C, described below:

PART A—Twelve grams of acrylic polyol (PARALOID AT-400, Rohm & Haas, Philadelphia, Pa.), 9.0 grams of dispersing agent (SOLSPERSE 36000, Lubrizol, Wickliffe, Ohio), and 36.5 g of MAK (EMCO Chemicals, North Chicago, Ill.) was added to a kettle and stirred thoroughly. 34.6 grams of TiO₂ pigment (TI-PURE R-960, E.I. du Pont de Nemours and Co., Edge Moor, Del.), 3.0 grams of yellow ceramic pigment (AY-610, Kawamura Chemicals Co., Ltd., Yokkaichishi, Japan), and 0.4 grams of brown ceramic pigment (AR-300, Kawamura Chemicals Co., Ltd., Yokkaichishi, Japan) were then added to the kettle along with about 200 grams of 1.8 mm zirconium beads (Quackenbush, Crystal Lake, Ill.). The resulting mixture was then dispersed with a high-speed Cowles blade until the mixture achieved a fineness rating of 8 or greater on a Hegman gauge. The mixture was then filtered to remove any clumps. Next, 2.6 grams of epoxy resin (EPON 828, Miller Stephenson, Morton Grove, Ill.) was added to the mixture under constant agitation. Finally, 2 grams of dibutyl tin dilaurate catalyst (Sigma-Aldrich, St. Louis, Mo.) was added with stirring.

PART B—Aliphatic polyisocyanate resin to promote cross-linking (DESMODUR N 75 BA, Bayer Material Science, Pittsburgh, Pa.).

PART C—Twenty-two grams of Xylene (EMCO Chemicals, North Chicago, Ill.) were mixed with 88 grams of methyl ethyl ketone (EMCO Chemicals, North Chicago, Ill.) to create a solvent for the dispersion.

One hundred grams of PART A were mixed with 5 grams of PART B, resulting in an isocyanate index of approximately 1.2. The mixture of PARTS A and B was then thinned down with 110 grams of PART C to produce a low-emissivity beige acrylic-polyurethane coating. The final coating had a viscosity of about 20 seconds by Ford # B4 viscosity cup (ASTM D1200).

The beige acrylic-polyurethane coating was applied in a very thin coat (about 5 μm) to aluminum test panels using a conventional gravity feed spray gun with about 30 p.s.i. pressure at a distance of about 1 ft. The panels were subjected to 10-15 minutes of flash-off, and were then cured at 350° F. for 20 minutes.

### Example 10

### Gray Acrylic-Polyurethane Coating Providing a Low Emissivity Coated Surface

A gray acrylic-polyurethane coating which provides a low emissivity coated surface was formed by making a 100:5:110 mixture of parts A, B, and C, described below:

PART A—12 grams of acrylic polyol (PARALOID AT-400, Rohm & Haas, Philadelphia, Pa.), 9.1 grams of dispersing agent (SOLSPERSE 36000, Lubrizol, Wickliffe, Ohio), and 36.4 g of methyl amyl ketone (MAK) (EMCO Chemicals, North Chicago, Ill.) was added to a kettle and stirred thoroughly. Thirty-five grams of TiO₂ pigment (TI-PURE R-960, E.I. du Pont de Nemours and Co., Edge Moor, Del.) and 3 grams of black ceramic pigment (AG-235, Kawamura Chemicals Co., Ltd., Yokkaichishi, Japan) was then added to the kettle along with about 200 grams of 1.8 mm zirconium beads (Quackenbush, Crystal Lake, Ill.). The resulting mixture was then dispersed with a high-speed Cowles blade until the mixture achieved a fineness rating of 8 or greater on a Hegman gauge. The mixture was then filtered to remove any clumps. Next, 2.6 grams of epoxy resin (EPON 828, Miller Stephenson, Morton Grove, Ill.) was added to the mixture under constant agitation. Finally, 2 grams of dibutyl tin dilaurate catalyst (Sigma-Aldrich, St. Louis, Mo.) was added with stirring.

PART B—Aliphatic polyisocyanate resin to promote cross-linking (DESMODUR N 75 BA, Bayer Material Science, Pittsburgh, Pa.).

PART C—Twenty-two grams of Xylene (EMCO Chemicals, North Chicago, Ill.) is mixed with 88 grams of methyl ethyl ketone (EMCO Chemicals, North Chicago, Ill.) to create a solvent for the dispersion.

One hundred grams of PART A were mixed with 5 grams of PART B, resulting in an isocyanate index of approximately 1.2. The mixture of PARTS A and B was then thinned down with 110 grams of PART C to produce a low-emissivity gray acrylic-polyurethane coating. The final coating had a viscosity of about 20 seconds by Ford # B4 viscosity cup (ASTM D1200).

The gray acrylic-polyurethane coating was applied in a very thin coat (about 5 μm) to aluminum test panels using a conventional gravity feed spray gun with about 30 p.s.i. pressure at a distance of about 1 ft. The panels were subjected to 10-15 minutes of flash-off, and were then cured at 350° F. for 20 minutes. After being removed from the oven, the panels were allowed to cool for 20 minutes and then tested (see Table 6).

TABLE 6
Low-e gray acrylic-polyurethane coating;
test material = aluminum panel.

| | | | Pigment weight | Thickness | |
|---|---|---|---|---|---|
| Formulation | Polymer | Pigment | of formulation | (microns) | Emissivity |
| 10-A | Acrylic- | TiO₂ + | 16% | 5 | 0.6 |
| | PU | black | | | |

The low-e gray acrylic-polyurethane coating was also evaluated for adhesion and hardness. The low-e gray acrylic-polyurethane coating passed the ASTM D 3359 initial adhesion test, and showed no signs of defects after 500 hours at 100° C. in a QCT (humidity) chamber. The low-e gray acrylic-polyurethane coating had a pencil hardness of 2H, a mineral spirit solvent double rub score of greater than 50, and showed no sign of defects after being subjected to the WINDEX chemical resistance test for 24 hours. The low-e gray acrylic-polyurethane coating also showed no blistering, fading, or discoloration after 500 hours in a QUV (ultraviolet light) chamber.

Thus, the invention provides, among other things, a variety of compositions that reduce the emissivity of a material or make use of the inherent emissivity of the material while providing a durable covering that is aesthetically pleasing.

All publications, patents, and patent applications are herein expressly incorporated by reference to the same extent as if each individual publication, patent, or patent application was specifically and individually indicated by reference. In case of conflict between the present disclosure and the incorporated patents, publications and references, the present disclosure should control.

Further, no admission is made that any reference, including any patent or patent document, cited in this specification constitutes prior art. In particular, it will be understood that, unless otherwise stated, reference to any document herein does not constitute an admission that any of these documents form part of the common general knowledge in the art in the United States or in any other country. Any discussion of the references states what their authors assert, and the applicant reserves the right to challenge the accuracy and pertinency of any of the documents cited herein.

Various features and advantages of the invention are set forth in the following claims.

What is claimed is:

1. A composition for coating materials, comprising;
a resin comprising polymerized organic monomers;
a dispersible electrically conductive material;
a cross-linking catalyst; and
a solvent,
wherein the organic monomers have at least one organic functional group, and wherein the resin, dispersible electrically conductive material, catalyst, and solvent are mixed together to form a homogenous composition.

2. The composition of claim 1, wherein the resin is chosen from the group consisting of acrylics, polyesters, alkyds, polyethers, polyureas, polyurethanes, polyketones, fluoropolymers, epoxies, or a combination thereof.

3. The composition of claim 2, wherein the resin comprises polymerized vinylidene fluoride monomers or polymerized acryl monomers.

4. The composition of claim 1, wherein the dispersible electrically conductive material comprises metal flakes chosen from the group consisting of silver, gold, aluminum, copper, nickel, and tin.

5. The composition of claim 1, wherein the dispersible electrically conductive material is chosen from the group consisting of glass fibers, glass beads, silica fibers, silica beads, carbon fibers, and ceramic beads coated with an electrically conductive material.

6. The composition of claim 1, wherein the cross linking catalyst is an amine salt of an organic sulfonic acid or comprises tin.

7. The composition of claim 6, wherein the catalyst is a diisopropanolamine salt of para-toluene sulfonic acid or dibutyl tin laurate.

8. The composition of claim 1, further comprising a pigment or dye.

9. The composition of claim 1, further comprising an adhesive agent.

10. A method for producing an article with low surface emissivity comprising coating an article with a composition comprising;
a resin comprising polymerized organic monomers;
a dispersible electrically conductive material;
a catalyst; and
a solvent,
wherein the resin, dispersible electrically conductive material, catalyst, and solvent are mixed together to form a homogenous composition.

11. The method of claim 10, wherein the article has a metal surface, and the metal surface is untreated, chemically pretreated, or physically pretreated prior to coating with the composition.

12. The method of claim 10, wherein the article is coated with a low emissivity primer prior to coating with the composition.

13. The method of claim 10, wherein the coating has a thickness less than 100 microns and greater than 1 micron.

14. The method of claim 10, wherein the coating has a thickness less than or equal to 10 microns.

15. The method of claim 10, wherein the coating further comprises a pigment or dye.

16. The method of claim 10, wherein the coating further comprises an adhesive agent.

17. The method of claim 10, wherein the coating has a pencil hardness of harder than or equal to about H.

18. The method of claim 10, wherein the article with low surface emissivity has a surface emissivity less than 0.7.

19. The method of claim 10, wherein the article with low surface emissivity has a surface emissivity less than 0.5.

20. The method of claim 10, further comprising coating the article with a protective clear coating less than 10 microns thick.

21. The method of claim 10, wherein the article with low surface emissivity is a building material.

22. The method of claim 21, wherein the building material is selected from the group consisting of window frames, doors, roof coverings, and exterior wall coverings.

23. A method for producing an article with low emissivity comprising coating an article with a composition comprising;
a resin comprising polymerized organic monomers;
a cross-linking catalyst; and
a solvent,
wherein the resin, catalyst, and solvent are mixed together, with no dispersible electrically conductive material, to form a homogenous composition.

24. The method of claim 23, wherein the article has a metal surface, and the metal surface is untreated, chemically pretreated, or physically pretreated prior to coating with the composition.

25. The method of claim 23, wherein the composition further comprises a pigment or dye.

26. The method of claim 23, wherein the composition further comprises an adhesive agent.

27. The method of claim 23, wherein the coating has a thickness of less than 10 microns.

28. The method of claim 23, wherein the coating has a thickness greater than 1 micron.

29. The method of claim 23, wherein the coating has a pencil hardness of harder than or equal to about H.

30. The method of claim 23, wherein the article with low surface emissivity has an effective emissivity less than 0.7.

31. The method of claim 23, wherein the article with low surface emissivity has an effective emissivity less than 0.5.

32. The method of claim 23, wherein the article with low surface emissivity is a building material.

33. The method of claim 32, wherein the building material is selected from the group consisting of window frames, doors, roof coverings, and exterior wall coverings.

34. An article with low surface emissivity, comprising an article coated with a composition consisting essentially of:
about 25-50% (w/w) resin comprising polymerized organic monomers;
about 25-50% (w/w) dispersible electrically conductive material;
about 25-50% (w/w) solvent; and
about 0.001-0.1% (w/w) cross-linking catalyst,
wherein the resin, dispersible electrically conductive material, solvent, and cross-linking catalyst are mixed together to form a homogenous composition, and wherein the coating has a thickness of less than 100 microns.

35. The method of claim 34, wherein the article with low surface emissivity is a building material.

36. The method of claim 35, wherein the building material is selected from the group consisting of window frames, doors, roof coverings, and exterior wall coverings.

37. An article with low surface emissivity, comprising an article coated with a composition consisting essentially of:
about 30-60% (w/w) resin comprising polymerized organic monomers;
about 40-70% (w/w) solvent; and
about 0.01-1% (w/w) cross-linking catalyst,
wherein the resin, solvent, and cross-linking catalyst are mixed together to form a homogenous composition, and wherein the coating has a thickness of less than 10 microns.

38. The method of claim 37, wherein the article with low surface emissivity is a building material.

39. The method of claim 38, wherein the building material is selected from the group consisting of window frames, doors, roof coverings, and exterior wall coverings.
